(19) United States
(12) Patent Application Publication
(10) Pub. No.: US 2010/0326677 A1
(43) Pub. Date: Dec. 30, 2010

(54) WATER MIST HEAD FOR A FIRE FIGHTING SYSTEM

(76) Inventors: Jens T. Jepsen, Klarup (DK); Erik Christensen, Odense SOE (DK)

Correspondence Address: MCCORMICK, PAULDING & HUBER LLP, CITY PLACE II, 185 ASYLUM STREET, HARTFORD, CT, 06103, US

(21) Appl. No.: 12/811,429

(22) PCT Filed: Dec. 18, 2008
(86) PCT No.: PCT/DK08/00439

§ 371 Date: Sep. 16, 2010

(30) Foreign Application Priority Data
Jan. 4, 2008 (DK) PA 2008 00015

(51) Int. Cl. A62C 37/08

(52) U.S. Cl. 169/37

(57) ABSTRACT

A water mist head (1) for a fire fighting system, the water mist head (1) being mounted at least 15 cm from a ceiling (5) or a wall (10). The water mist head (1) comprises a nozzle part (2) comprising a plurality of nozzles (3), and a plate (6) comprising an at least substantially plane part (7). The plate (6) is arranged between the nozzle part (2) and the ceiling (5) or wall (10), preferably adjacent to the nozzle part (2). The plate (6) prevents the sprays (4) produced by the nozzles (3) from pulling air along. Thereby it is prevented that the sprays (4) ‘collapse’, and a more diverted spray patter is obtained, the water mist head (1) thereby being capable of covering a larger area. Thus, the plate (6) creates an effect similar to that of a ceiling or wall arranged adjacent to or near the nozzle part (2).

### CROSS REFERENCE TO RELATED APPLICATIONS

This application is entitled to the benefit of and incorporates by reference essential subject matter disclosed in International Patent Application No. PCT/DK2008/000439 filed on Dec. 18, 2008 and Danish Patent Application No. PA 2008 00015 filed Jan. 4, 2008.

### FIELD OF THE INVENTION

The present invention relates to a water mist head for a fire fighting system, in particular for a fire fighting system which is suitable for being mounted inside buildings, or in vessels, such as ships, and which is automatically or manually activated in case a fire occurs inside the building/vessel. More particularly, the present invention relates to a water mist head which is mounted at a significant distance from a ceiling of the room where the fire fighting system is installed. The water mist head of the present invention provides an improved spray pattern of fire suppressant as compared to similar prior art water mist heads mounted at a distance from a ceiling. Furthermore, the water mist head of the present invention allows for sufficient fire protection while using a lower number of water mist head than is necessary in fire fighting systems using prior art water mist heads.

### BACKGROUND OF THE INVENTION

When a fire fighting system is installed in an interior part of a building it is normally desirable to mount the water mist heads at positions close to a ceiling or a wall. This is due to aesthetic as well as practical reasons, since water mist heads arranged at a distance from a ceiling or a wall are normally in the way with respect to the normal use of the room. However, sometimes it is not possible to mount the water mist heads immediately adjacent to, e.g., a ceiling. This is, e.g., the case when lamps and/or pipes are located at positions near the ceiling. In this case the water mist heads must be arranged further away from the ceiling than the lamps/pipes, since the lamps/pipes would otherwise block a spray of fire suppressant from a given water mist head, and the fire fighting system would thereby not be able to operate in a correct manner, and it may even be impossible for the fire fighting system to extinguish a fire under these circumstances.

Mounting a water mist head at a required distance from a ceiling as described above, has an adverse effect on the spray pattern provided by the water mist head. A spray generated by a nozzle tends to pull air along the direction of the spray. When multiple sprays arranged in the vicinity of each other pulls air along in this manner, the sprays tend to ‘collapse’ in such a manner that the resulting spray pattern is more directional and less diverted. As a consequence, the water mist head covers a smaller area and more water mist heads a necessary in order to cover a given room sufficiently. Accordingly, the spray pattern is disturbed and a less efficient fire suppression is obtained.

WO 92/15370 discloses a spray-head for fighting fire. The spray-head comprises two systems, one producing fog-like fire fighting liquid using a relatively small amount of fire fighting liquid, and one producing water drops for fighting more serious fires, e.g. in the case that over-ignition takes place. In order to prevent that the fog-like fire fighting liquid cools the activation system of the second system, an umbrella-like member may be provided, the umbrella-like member shielding the activation system from the fog-like fire fighting liquid and simultaneously directing heated air moving upwards from the location of the fire towards the activation system of the second fire fighting system in order to cause a rapid activation of the water drop producing system.

EP 1 413 333 discloses a sprinkling head for fire fighting systems. The sprinkling head comprises a nozzle holder cap which is removably coupled to a body of the sprinkling head. The sprinkling head may comprise a parabolic element adapted to reflect infrared radiation towards an activation device for the sprinkling head, similarly to the function of the umbrella-like member disclosed in WO 92/15370.

WO 99/34872 discloses a holder for mounting a spray head. The holder is mounted in a ceiling, and a spray head is subsequently mounted in the holder. The spray head may be provided with a plate for hiding screws etc. used for mounting the holder in the ceiling.

The water mist heads disclosed in WO 92/15370, EP 1 413 333 and WO 99/34872 are all mounted close to a ceiling.

### SUMMARY OF THE INVENTION

It is, thus, an object of the invention to provide a water mist head for a fire fighting system, the water mist head providing an improved spray pattern when mounted at a distance from a ceiling.

It is a further object of the invention to provide a water mist head for a fire fighting system, the water mist head being able to cover a larger area than similar prior art water mist heads.

It is an even further object of the invention to provide fire fighting system comprising at least one water mist head providing an improved spray patter when the water mist head is mounted at a distance from a ceiling.

It is an even further object of the invention to provide a fire fighting system in which the number of water mist heads necessary for covering a given area can be reduced as compared to similar prior art fire fighting systems.

According to the invention the above and other objects are fulfilled by providing a water mist head mounted at least 15 cm from a ceiling or a wall of an interior part of a room, the water mist head comprising:
a nozzle part comprising a plurality of spray nozzles, each being adapted to produce a spray of fire suppressant, said nozzle part being connected to a fire suppressant source,
a plate comprising an at least substantially plane part, said plate being arranged between the nozzle part and the ceiling or wall.

In the present context the term ‘water mist head’ should be interpreted to mean a part of a fire fighting system which is adapted to produce a spray of fire suppressant.

According to the invention the water mist head is mounted at least 15 cm from a ceiling or a wall of an interior part of a room, e.g. of a building or a vessel, such as a ship. The building may any kind of building, such as a building being suitable for accommodation, an office building, an industrial building, such as a storage facility or a factory, a sports facility, etc. The interior part may be a room, a hall, an office, etc.

The water mist head comprises a nozzle part, i.e. a part comprising a plurality of spray nozzles, each being adapted to produce a spray of fire suppressant using fire suppressant supplied to the nozzle part from a fire suppressant source, upon activation of the water mist head in case of a fire in the interior part of the room. The sprays of fire suppressant are normally designed in such a manner that fire suppressant is directed towards the fire. The nozzles are preferably high pressure nozzles capable of generating a water mist at a pressure above 60 bar, such as approximately 100 bar.

As mentioned above, it is sometimes necessary to mount a water mist head at a distance from a ceiling or a wall, e.g. due to lamps and/or pipes mounted at or near the ceiling/wall. In this case the spray patterns of the sprays of fire suppressant produced by the water mist head will collapse as explained above, and it is therefore difficult to control the sprays of fire suppressant produced by the nozzles of the water mist head. Furthermore, the area covered by a given water mist head is reduced, and it is therefore necessary to use a higher number of water mist heads in order to provide sufficient fire protection for a given room. According to the present invention the water mist head is mounted at least 15 cm from a ceiling or a wall, preferably even further away from the ceiling or wall, such as at least 30 cm away. Collapse of the spray pattern would therefore occur under normal circumstances.

However, the water mist head of the present invention comprises a plate arranged between the nozzle part and the ceiling or wall. The plate comprises a substantially plane part, and the plate will therefore have an effect similar to that of the ceiling or wall when the water mist head is mounted close to, or even adjacent to, a ceiling or a wall. Thus, the plate at least substantially prevents the sprays from pulling air along, and collapse of the sprays can thereby be prevented, or at least significantly reduced, and disturbance of the spray pattern produced by the spray nozzles is thereby substantially avoided, regardless of the distance between the water mist head and the ceiling or wall. Accordingly, the actual spray pattern is identical to, or at least almost identical to, the designed spray pattern, i.e. the actual spray pattern is highly predictable, and it is more diverted than it would be if the plate had not been present. Thereby the water mist head is capable of covering a larger area. This allows a fire fighting system having the water mist head installed to be able to fight a fire very efficiently with a minimum number of water mist heads. The invention provides a water mist head providing an enhanced spray pattern when the water mist head is mounted at a significant distance, i.e. at least 15 cm, from a ceiling or wall. Thus, the water mist head of the invention allows the spray pattern to be controlled, regardless of the distance between the water mist head and the ceiling or wall, and the precise position of the water mist head may thereby be chosen based on other criteria, such as optimal position relatively to expected locations of fire, avoiding shadow effects from lamps or piping, etc.

The most significant effect of the present invention is obtained when the water mist head is mounted at a distance from a substantially horizontal ceiling, and the invention is therefore particularly suitable for water mist heads mounted from a ceiling. However, an effect is also obtained when the water mist head is mounted at a distance from a substantially vertical wall, or from a sloping ceiling or wall, and the invention may therefore also be applied in these situations.

The plate is preferably made from a heat resistant material. In particular, the material of the plate is preferably chosen in such a manner that the plate maintains its shape at temperatures which are expected to occur at the position of the plate during a fire. Many fire fighting systems are operated by means of an automatic activation mechanism which activates the nozzles in case a fire is detected. Some of these automatic activation mechanisms comprise a bulb arranged at or near one or more of the water mist heads. When the temperature in the region of the bulb exceeds a predefined threshold temperature, the bulb breaks, thereby causing activation of the fire fighting system. Once the nozzles start producing sprays of fire suppressant the plate will be cooled by the produced sprays. However, it is important that the shape of the plate is maintained at the temperatures which the plate is expected to experience until then. Accordingly, the plate should at least be able to maintain its shape at temperatures up to the threshold temperature which causes the bulb to break. A suitable threshold temperature is approximately 200° C.

The plate may be made from a suitable metal or alloy, e.g. aluminium or stainless steel. As an alternative, the plate may be made from a hard and heat resistant plastic. It should be noted that the plate should be made from a hard or stiff material, i.e. a material which allows the plate to maintain its shape.

The plate may be arranged less than 15 cm from the nozzle part. This ensures that the plate is capable of preventing the spray from pulling air along in a region around the nozzle part sufficiently to control the spray pattern to a desired extent. The plate may even be arranged substantially adjacent to the nozzle part, in which case the water mist head will function substantially in the same manner as it would if it had been mounted immediately adjacent to a ceiling or a wall. The closer to the nozzle part the plate is arranged, the smaller a plate is necessary in order to obtain the desired effect. Accordingly, a desired effect can be obtained, even if the plate is mounted at some distance from the nozzle part, but a somewhat larger plate will be necessary in this case.

The plate may comprise a rim portion which is arranged adjacent to, and forming an angle relatively to, the at least substantially plane part. The rim portion helps in guiding the air arranged above the plate away from the sprays, thereby further preventing that air is pulled along by the sprays.

The plate may be formed from a single part, such as a single sheet of plate material, where the rim portion has been formed by bending a part of the plate, the bend defining the interface between the substantially plane part and the rim portion. Alternatively, the rim portion may be a separate part which is attached to the substantially plane part, e.g. using a suitable welding technique.

The rim portion may form an angle within the interval 1° to 90°, such as within the interval 15° to 90°, such as within the interval 30° to 90°, such as within the interval 45° to 90°, relatively to the substantially plane part. This will allow the rim portion to provide guidance for the air arranged in a region above the plate in a direction away from the sprays as described above in a particularly efficient manner.

The rim portion may define an area which is smaller than an area defined by the substantially plane part, preferably significantly smaller. According to this embodiment the substantially plane part forms the major part of the total area of the plate, the rim portion only forming a smaller part of the total area. This has the advantage that the dominating effect of the plate is that which is provided by the substantially plane part, i.e. preventing the sprays from pulling air along, thereby causing the sprays to collapse. If the area of the rim portion is relatively large as compared to the area of the substantially plane part, then there is a risk that the plate functions as a parabolic reflector ‘catching’ air and leading it towards the nozzle part. It is not desirable that this effect becomes dominating, and it is therefore advantageous to ensure that the area defined by the rim portion is smaller than the area defined by the substantially plane part.

Alternatively or additionally, the rim portion may extend a distance from the substantially plane part, said distance being within the interval 0.5 cm to 5 cm, such as within the interval 0.5 cm to 3 cm, such as approximately 1 cm. As mentioned above, it is preferred that the dimensions of the rim portion are kept relatively small relatively to the dimensions of the substantially plane part.

The substantially plane part of the plate may define a representative length which is within the interval 150 mm to 300 mm, such as within the interval 170 mm to 250 mm, such as approximately 200 mm. In the present context the term ‘representative length’ should be interpreted as a length which is significant for the dimensions of the substantially plane part.

Thus, the substantially plane part may have a substantially circular shape, and the representative length may in this case be a radius of the circular shape. As an alternative, the substantially plane part may have a substantially quadratic shape, and the representative length may in this case be a length of a side of the quadratic shape. Alternatively, the substantially plane part may have any other suitable shape, and the representative length may be any length which is significant for the overall dimensions of the substantially plane part.

Each of the nozzles may be adapted to produce a mist of fire suppressant. The present invention is particularly suitable in this case, because the spray pattern of a mist of fire suppressant is very likely to collapse as a consequence of air being pulled along by the sprays. However, one or more, or even all of, the nozzles may be adapted to produce drops or droplets of fire suppressant. The invention will also be useful in this situation, since a spray pattern of drops or droplets will also be affected as described, at least to some extent.

The nozzle part may be connected to a source of water based fire suppressant, e.g. substantially pure water. In this case the source of fire suppressant may be a reservoir containing water or another water based fire suppressant, or it may be a tap connecting the nozzle part to an ordinary water supply. It is desirable to use a water based fire suppressant, because such fire suppressants are normally non-toxic and favourable from an environmental point of view. However, the fire suppressant may alternatively be any other suitable or desirable kind of fire suppressant.

The present invention further relates to a fire fighting system mounted in an interior part of a building or a vessel, said fire fighting system comprising a fire suppressant source and at least one water mist head according to the invention and as described above. Such a fire fighting system very often comprises a number of water mist heads arranged strategically at various positions of the room to be protected, in such a manner that fire occurring at any position of the room can be efficiently extinguished. Such a fire fighting system will often comprise water mist heads mounted from the ceiling as well as water mist heads mounted from one or more walls. Since the water mist heads as described above are capable of covering a large area, a lower number of water mist heads is necessary in the fire fighting system according to the invention in order to provide sufficient fire protection for a given room.

### BRIEF DESCRIPTION OF THE DRAWINGS

The invention will now be described in further detail with reference to the accompanying drawings in which

FIG. 1 is a schematic view of a water mist head according to a first embodiment of the invention, the water mist head being mounted at a distance from a ceiling,

FIG. 2 is a schematic view of a water mist head according to a second embodiment of the invention, the water mist head being mounted at a distance from a ceiling,

FIG. 3 is a schematic view of a water mist head according to a third embodiment of the invention, the water mist head being mounted at a distance from a wall,

FIG. 4 is a side view of a water mist head according to a fourth embodiment of the invention, and

FIG. 5 is a cross sectional view along the line A-A of the water mist head of FIG. 4.

### DETAILED DESCRIPTION OF THE DRAWINGS

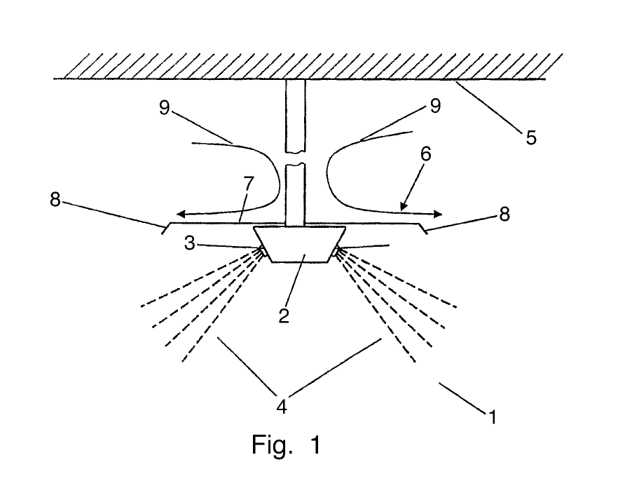

FIG. 1 is a schematic view of a water mist head 1 according to a first embodiment of the invention. The water mist head 1 comprises a nozzle part 2 comprising a number of spray nozzles 3, two of which are visible. Each of the spray nozzles 3 is fluidly connected to a source of fire suppressant (not shown), and is adapted to produce a spray 4 of fire suppressant, preferably in the form of a mist. The nozzle part 2 is arranged at a distance from a ceiling 5.

The water mist head 1 is further provided with a plate 6 comprising a substantially plane part 7 and a rim portion 8 which is angled relatively to the substantially plane part 7. The plate 6 is positioned adjacent to the nozzle part 2 and between the nozzle part 2 and the ceiling 5.

The water mist head 1 shown in FIG. 1 preferably operates in the following manner. When a fire is detected in the room where the water mist head 1 is mounted, the water mist head 1 is activated, and the spray nozzles 3 start producing sprays 4 of fire suppressant in order to fight the fire. Due to the plate 6, the sprays 4 are prevented from pulling air along, and it is therefore prevented that the sprays 4 collapse as described above. Instead, the flow of air in the region of the spray nozzles 3 will be as indicated by arrows 9. Thereby the spray pattern produced by the nozzles 3 does not collapse, and it is therefore possible to design the nozzles 3 to produce a desired spray pattern, and to ensure that the designed spray pattern is the actual spray pattern which occurs when the water mist head 1 is activated in case of a fire. Furthermore, since the diverting spray pattern is maintained, the water mist head 1 is capable of covering an increased area, and a smaller number of water mist heads 1 will therefore be necessary in order to provide sufficient fire protection for a given room.

If the plate 6 had not been present, the following would happen. When the spray nozzles 3 are activated as described above, each of the sprays 4 will pull aur along in the direction of the spray 4. Since the sprays 4 are positioned close to each other, and since each of the sprays 4 pulls air along in this manner, the sprays 4 will ‘collapse’ in the sense that the resulting spray pattern becomes less diverted and will be directed more in a direct downwards direction. In other words the ‘opening angle’ defined by the spray pattern will be smaller, and the area covered by the water mist head 1 will consequently become smaller.

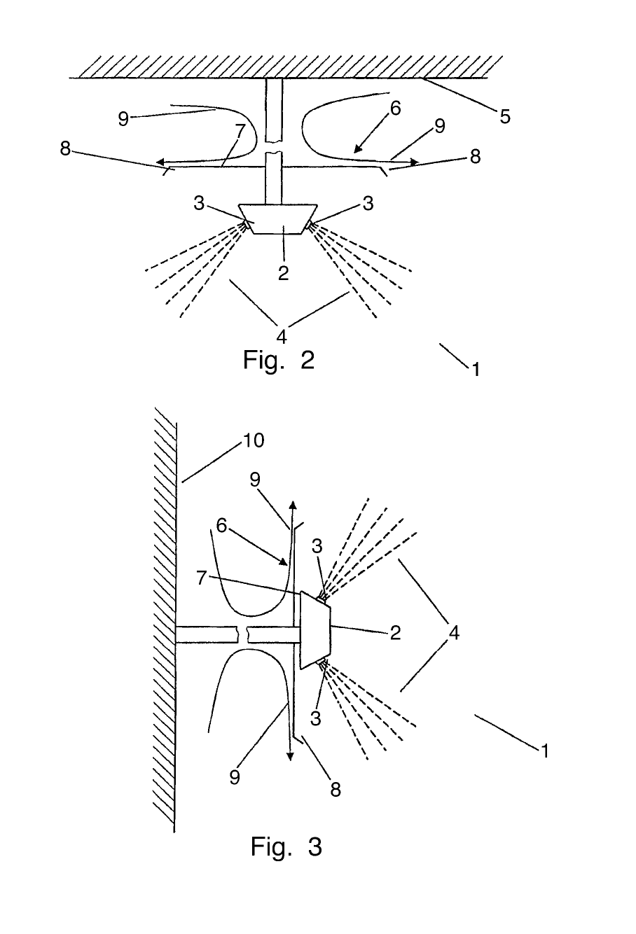

FIG. 2 is a schematic view of a water mist head 1 according to a second embodiment of the invention. Similarly to the situation described above with reference to FIG. 1, the water mist head 1 of FIG. 2 is mounted at a distance from a ceiling 5. The water mist head 1 shown in FIG. 2 is very similar to the water mist head 1 shown in FIG. 1, and it will therefore not be described in detail here.

In the water mist head 1 shown in FIG. 2 the plate 6 is arranged at a distance from the nozzle part 2. However, it is still sufficiently close to the nozzle part 2 to provide the effect described above as indicated by arrows 9, thereby at least substantially preventing the sprays 4 from pulling air along. Comparing FIG. 1 and FIG. 2 it can be seen that the plate 6 of the water mist head 1 of FIG. 2 is somewhat larger than the plate 6 of the water mist head 1 of FIG. 1. This is necessary due to the distance between the nozzle part 2 and the plate in FIG. 2, and in order to obtain a desired effect.

FIG. 3 is a schematic view of a water mist head 1 according to a third embodiment of the invention. In FIG. 3 the water mist head 1 is mounted at a distance from a wall 10. Apart from that, the water mist head 1 of FIG. 3 is substantially identical to the water mist head 1 of FIG. 1, and it operates essentially as described above. As indicated by arrows 9, the plate 6 guides air in a region around the water mist head 1 in such a manner that the sprays 4 are prevented from pulling air along. Accordingly, the effect described aboce is also obtained here.

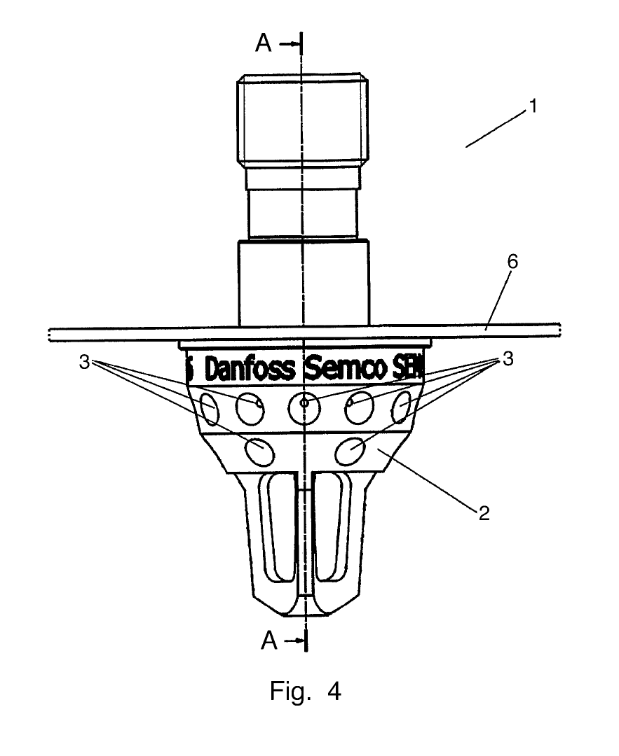

FIG. 4 is a side view of a water mist head 1 according to a fourth embodiment of the invention. The water mist head 1 comprises a nozzle part 2 and a plate 6 as described above with reference to FIG. 1. The nozzle part 2 is provided with a number of nozzles 3, seven of which are visible.

Only part of the plate 6 is visible, and it should be understood that the plate 6 extends further in a substantially horizontal direction. The part of the plate 6 which is visible is substantially plane.

The water mist head 1 of FIG. 4 is operated essentially as described above with reference to FIG. 1.

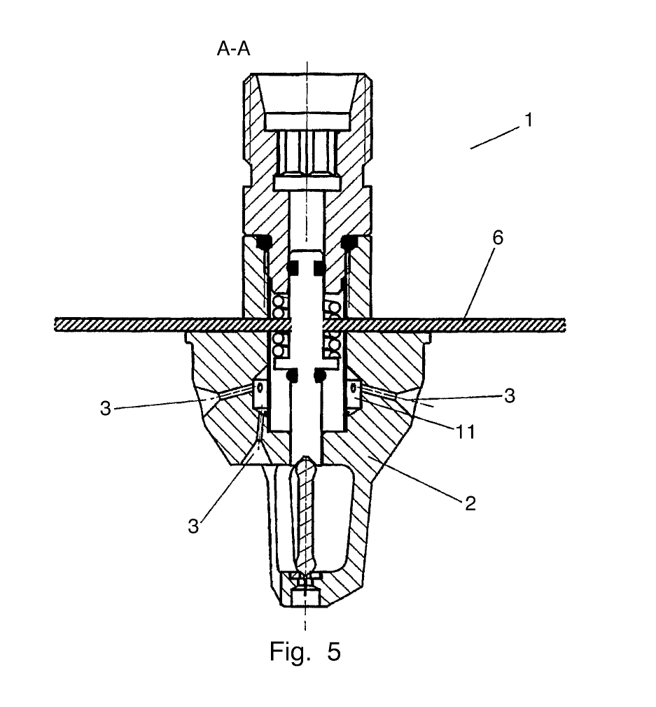

FIG. 5 is a cross sectional view along the line A-A of the water mist head 1 of FIG. 4. It can be seen that the nozzles 3 are all connected to a fire suppressant supply 11. The fire suppressant supply 11 is further connected to a fire suppressant source (not shown). The fire suppressant source may be a reservoir containing a suitable kind of fire suppressant, or it may simply be a tap connected to the normal water supply.

While the present invention has been illustrated and described with respect to a particular embodiment thereof, it should be appreciated by those of ordinary skill in the art that various modifications to this invention may be made without departing from the spirit and scope of the present.

What is claimed is:

1. A water mist head mounted at least 15 cm from a ceiling or a wall of an interior part of a room, the water mist head comprising:
a nozzle part comprising a plurality of spray nozzles, each being adapted to produce a spray of fire suppressant, said nozzle part being connected to a fire suppressant source,
a plate comprising an at least substantially plane part, said plate being arranged between the nozzle part and the ceiling or wall.

2. The water mist head according to claim 1, wherein the plate is arranged less than 15 cm from the nozzle part.

3. The water mist head according to claim 2, wherein the plate is arranged substantially adjacent to the nozzle part.

4. The water mist head according to claim 1, wherein the plate comprises a rim portion which is arranged adjacent to, and forming an angle relatively to, the at least substantially plane part.

5. The water mist head according to claim 4, wherein the rim portion forms an angle within the interval 1° to 90° relatively to the substantially plane part.

6. The water mist head according to claim 4, wherein the rim portion defines an area which is smaller than an area defined by the substantially plane part.

7. The water mist head according to claim 4, wherein the rim portion extends a distance from the substantially plane part, said distance being within the interval 0.5 cm to 5 cm.

8. The water mist head according to claim 1, wherein the substantially plane part of the plate defines a representative length which is within the interval 150 mm to 300 mm.

9. The water mist head according to claim 8, wherein the substantially plane part has a substantially circular shape, and wherein the representative length is a radius of the circular shape.

10. The water mist head according to claim 8, wherein the substantially plane part has a substantially quadratic shape, and wherein the representative length is a length of a side of the quadratic shape.

11. The water mist head according to claim 1, wherein each of the nozzles is adapted to produce a mist of fire suppressant.

12. The water mist head according to claim 1, wherein the nozzle part is connected to a source of water based fire suppressant.

13. A fire fighting system mounted in an interior part of a building, said fire fighting system comprising a fire suppressant source and at least one water mist head according to any of the preceding claims claim 1.
